(19) United States
(12) Patent Application Publication
(10) Pub. No.: US 2020/0183838 A1
(43) Pub. Date: Jun. 11, 2020

(54) DYNAMIC CACHE RESIZE TAKING INTO ACCOUNT UNDERLYING RAID CHARACTERISTICS

(71) Applicant: International Business Machines Corporation, Armonk, NY (US)

(72) Inventors: Wendy L. Henson, Portland, OR (US); Robert E. Jose, Beaverton, OR (US); Kushal Patel, Pune (IN); Sarvesh Patel, Pune (IN)

(73) Assignee: International Business Machines Corporation, Armonk, NY (US)

(21) Appl. No.: 16/214,971

(22) Filed: Dec. 10, 2018

(51) Int. Cl. G06F 12/0804; G06F 12/0868

(52) U.S. Cl. CPC G06F 12/0804; G06F 2212/262; G06F 2212/1044; G06F 12/0868

(57) ABSTRACT

A method for resizing write cache in a storage system is disclosed. In one embodiment, such a method includes maintaining, in a write cache, write data to be destaged to RAID arrays implemented on persistent storage drives. The method dynamically resizes the write cache in a way that takes into account the following: (1) an amount of battery power available to destage the write data to the persistent storage drives in the event of an emergency; and (2) underlying characteristics of the RAID arrays to which the write data is to be destaged. A corresponding system and computer program product are also disclosed.

### BACKGROUND

### Field of the Invention

This invention relates to systems and methods for dynamically resizing write cache in enterprise storage systems.

### Background of the Invention

In an enterprise storage system such as the IBM DS8000™ enterprise storage system, a pair of servers may be used to access data in one or more storage drives (e.g., hard-disk drives and/or solid-state drives). During normal operation (when both servers are operational), the servers may manage I/O to different logical subsystems (LSSs) within the enterprise storage system. For example, in certain configurations, a first server may handle I/O to even LSSs, while a second server may handle I/O to odd LSSs. These servers may provide redundancy and ensure that data is always available to connected hosts. When one server fails, the other server may pick up the I/O load of the failed server to ensure that I/O is able to continue between the hosts and the storage drives. This process may be referred to as a “failover.”

Each server in the storage system may include one or more processors and memory. The memory may include volatile memory (e.g., RAM) as well as non-volatile memory (e.g., ROM, EPROM, EEPROM, flash memory, local hard drives, local solid state drives, etc.). The memory may include a cache, such as a DRAM cache. Whenever a host (e.g., an open system or mainframe server) performs a read operation, the server that performs the read may fetch data from the storage drives and save it to its cache in the event it is required again. If the data is requested again by a host, the server may fetch the data from the cache instead of fetching it from the storage drives, saving both time and resources. Similarly, when a host performs a write, the server that receives the write request may store the modified data in its cache, and destage the modified data to the storage drives at a later time. When modified data is stored in cache, the modified data may also be stored in non-volatile storage (NVS) of the opposite server so that the modified data can be recovered by the opposite server in the event the first server fails. In certain embodiments, the NVS is implemented as battery-backed volatile memory in the opposite server.

When a storage system such as the IBM DS8000™ enterprise storage system experiences a power outage, the modified data in the NVS may be quickly copied under battery power to more persistent storage (e.g., a local disk drive, solid state drive, and/or flash drive). The energy in the backup battery needs to be sufficient to complete the copy process. If a battery is degraded, a copy process is not initiated quickly enough after the storage system goes on battery power, and/or a cache or NVS is too large or contains too much data, the battery may not have sufficient energy to complete the copy process. In such cases, data loss may result.

In view of the foregoing, what are needed are systems and methods to ensure that modified data in a cache or NVS is not lost in the event of a power outage. Further needed are systems and methods to ensure that, in the event of a power outage, data is promptly and reliably copied from the cache or NVS to more persistent storage. Yet further needed are systems and methods to ensure that a dynamically resizable cache or NVS is not so large that its data cannot be reliably copied to persistent storage before a backup battery is depleted.

### SUMMARY

The invention has been developed in response to the present state of the art and, in particular, in response to the problems and needs in the art that have not yet been fully solved by currently available systems and methods. Accordingly, systems and methods have been developed for dynamically resizing write cache in enterprise storage systems. The features and advantages of the invention will become more fully apparent from the following description and appended claims, or may be learned by practice of the invention as set forth hereinafter.

Consistent with the foregoing, a method for resizing write cache in a storage system is disclosed. In one embodiment, such a method includes maintaining, in a write cache, write data to be destaged to RAID arrays implemented on persistent storage drives. The method dynamically resizes the write cache in a way that takes into account the following: (1) an amount of battery power available to destage the write data to the persistent storage drives in the event of an emergency; and (2) underlying characteristics of the RAID arrays to which the write data is to be destaged.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a network environment in which systems and methods in accordance with the invention may be implemented;

FIG. 2 is a high-level block diagram showing one example of a storage system for use in the network environment of FIG. 1;

FIG. 3 is a high-level block diagram showing write amplification when destaging data from cache to different types of RAIDs;

FIG. 4 is a high-level block diagram showing resizing of the cache when promoting data to cache from different types of RAIDs;

FIG. 5 is a flow diagram showing one embodiment of a method for promoting data from a RAID to cache; and

FIG. 6 shows various modules that may be included in or in association with a storage system to provide various features and functions in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

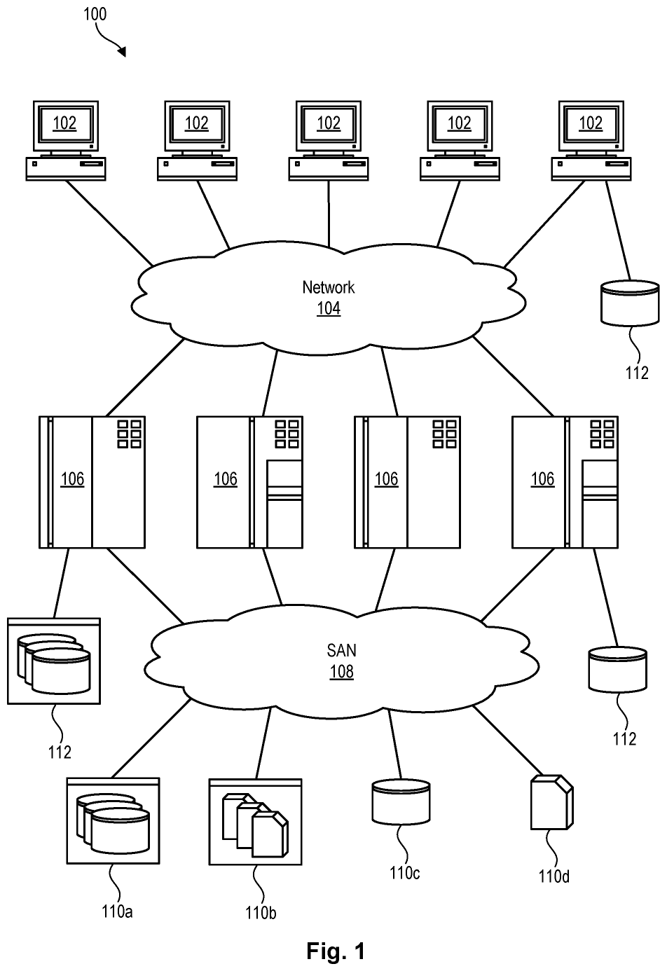

Referring to FIG. 1, one example of a network environment 100 is illustrated. The network environment 100 is presented to show one example of an environment where embodiments of the invention may operate. The network environment 100 is presented only by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC) or iSCSI.

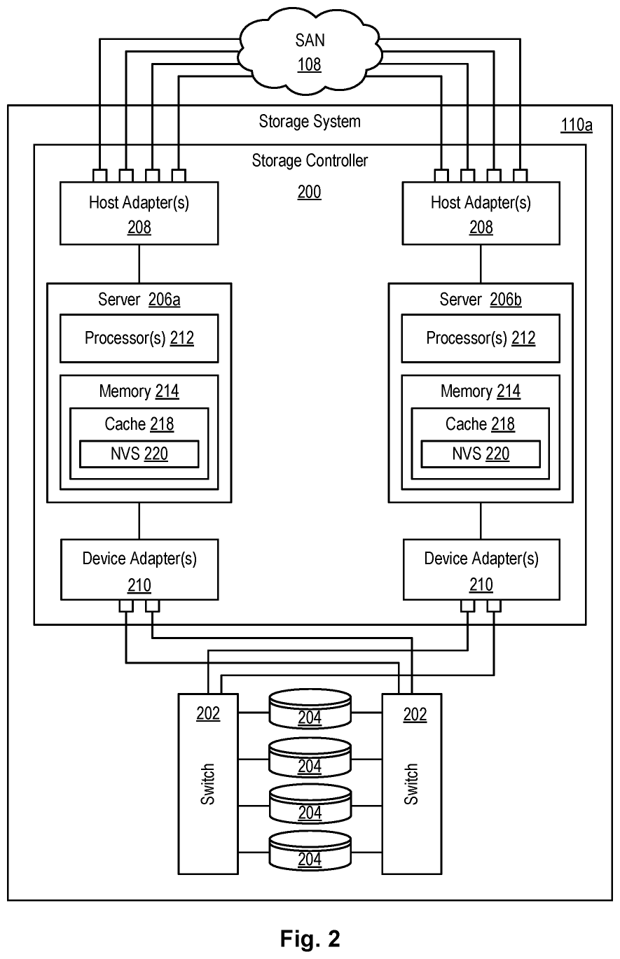

Referring to FIG. 2, one embodiment of a storage system 110a containing an array of storage drives 204 (e.g., hard-disk drives and/or solid-state drives) is illustrated. The internal components of the storage system 110a are shown since the systems and methods disclosed herein may, in certain embodiments, be implemented within such a storage system 110a, although the systems and methods may also be applicable to other storage systems. As shown, the storage system 110a includes a storage controller 200, one or more switches 202, and one or more storage drives 204 such as hard disk drives and/or solid-state drives (such as flash-memory-based drives). The storage controller 200 may enable one or more hosts 106 (e.g., open system and/or mainframe servers 106) to access data in the one or more storage drives 204.

In selected embodiments, the storage controller 200 includes one or more servers 206. The storage controller 200 may also include host adapters 208 and device adapters 210 to connect the storage controller 200 to host devices 106 and storage drives 204, respectively. During normal operation (when both servers 206 are operational), the servers 206 may manage I/O to different logical subsystems (LSSs) within the enterprise storage system 110a. For example, in certain configurations, a first server 206a may handle I/O to even LSSs, while a second server 206b may handle I/O to odd LSSs. These servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

In selected embodiments, each server 206 includes one or more processors 212 and memory 214. The memory 214 may include volatile memory (e.g., RAM) as well as non-volatile memory (e.g., ROM, EPROM, EEPROM, flash memory, local disk drives, local solid state drives etc.). The volatile and non-volatile memory may, in certain embodiments, store software modules that run on the processor(s) 212 and are used to access data in the storage drives 204. These software modules may manage all read and write requests to logical volumes in the storage drives 204.

In selected embodiments, the memory 214 includes a cache 218, such as a DRAM cache 218. Whenever a host 106 (e.g., an open system or mainframe server 106) performs a read operation, the server 206 that performs the read may fetch data from the storages drives 204 and save it in its cache 218 in the event it is required again. If the data is requested again by a host 106, the server 206 may fetch the data from the cache 218 instead of fetching it from the storage drives 204, saving both time and resources. Similarly, when a host 106 performs a write, the server 106 that receives the write request may store the write in its cache 218, and destage the write to the storage drives 204 at a later time. When a write is stored in cache 218, the write may also be stored in non-volatile storage (NVS) 220 of the opposite server 206 so that the write can be recovered by the opposite server 206 in the event the first server 206 fails. In certain embodiments, the NVS 220 is implemented as battery-backed cache 218 in the opposite server 206.

One example of a storage system 110a having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the systems and methods disclosed herein are not limited to the IBM DS8000™ enterprise storage system, but may be implemented in any comparable or analogous storage system or group of storage systems, regardless of the manufacturer, product name, or components or component names associated with the system. Any storage system that could benefit from one or more embodiments of the invention is deemed to fall within the scope of the invention. Thus, the IBM DS8000™ is presented only by way of example and is not intended to be limiting.

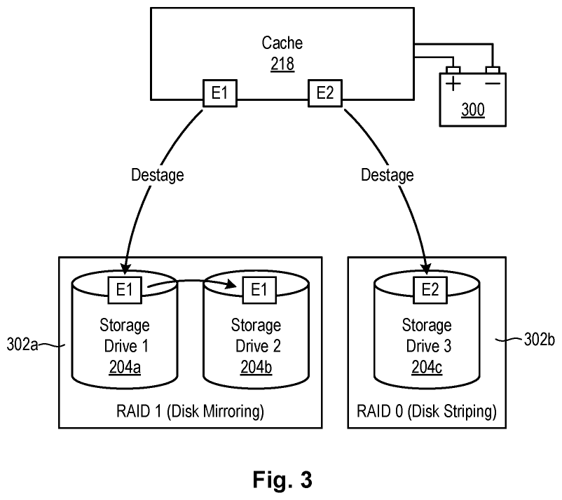

Referring to FIG. 3, when a storage system 110a such as that illustrated in FIG. 2 experiences a power outage, the modified data in the cache 218 may be quickly copied (also referred to as performing a “fire hose dump”) under battery power to more persistent storage (e.g., a local disk drive, solid state drive, flash drive, etc.). Ideally, this copy process will complete before energy in the battery 300 is depleted. It follows that the energy in the battery 300 needs to be sufficient to complete the copy process. If a battery 300 is degraded or the copy process is not initiated quickly enough after the storage system 110 goes on battery power, the battery 300 may not have sufficient energy to complete the copy process. In such cases, data loss may result. In such cases, modified data in the cache 218 may be all or partially lost.

In certain cases, the cache 218, and more particularly the write cache 218, may be dynamically resized based on the amount of energy stored in the battery 300. If less energy is available in the battery 300, the cache size may be reduced so that, in the event of a power outage or other emergency, all modified data in the cache 218 may be destaged before the battery 300 runs out of energy. If more energy is available in the battery 300, the cache size may be increased since more data may be destaged from cache 218 in the event of an emergency.

In addition to considering the amount of energy that is in the battery 300 when resizing a cache 218, systems and methods in accordance with the invention may consider backend storage drives 204 to which data is being destaged or from which data is being promoted. This is because more time may be required to destage data to some backend storage drives 204 than others. For example, backend storage drives 204 arranged in a RAID 1 array (i.e., disk mirroring) may require an increased number of backend writes than a RAID 0 array (i.e., disk striping) due to the need to mirror data between multiple backend storage drives 204. In other words, destaging an extent of data from cache 218 to a RAID 1 array will take significantly more time than destaging the same extent to a RAID 0 array due to the need to mirror the extent to other storage drives 204 in the RAID 1 array. That is, detstaging the extent from cache 218 will require multiple writes to the backend storage drives 204 in the RAID1 array.

This phenomena is shown in FIG. 3. As shown in FIG. 3, when destaging an extent (E1) from cache 218 to the RAID 1 array 302a, the extent may initially be written to the storage drive 204a. This extent may then be mirrored to the storage drive 204b, resulting in a second write. By contrast, when destaging an extent (E2) to the storage drive 204c in the RAID 0 array 302b, the extent may be written a single time. No other writes may be needed. Because two writes may be needed to write data to the RAID 1 array 302a, destaging data to the RAID 1 array 302a may require significantly more time than destaging the same data to the RAID 0 array 302b. Thus, with a given amount of energy in a battery 300, less data may be destaged to the RAID 1 array 302a than to the RAID 0 array 302b. It follows that the size of the cache 218 should be significantly smaller if it contains mostly data from the RAID 1 array 302a since it would take significantly more time to destage data from the cache 218 to the array 302a in the event of an emergency.

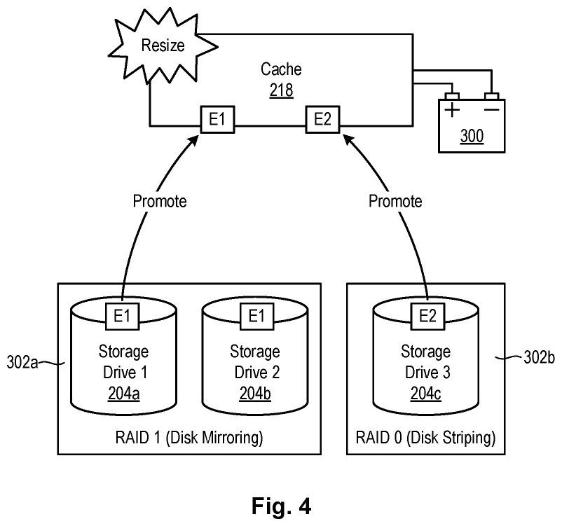

Referring to FIG. 4, when data is promoted from the arrays 302a, 302b to the cache 218, the cache 218 may be resized based on the source of the promoted data. If, for example, an extent (E1) of data is promoted from the RAID 1 array 302a to the cache 218, the size of the cache 218 may be reduced or kept smaller to reflect the increased amount of time it will take to destage this data from the cache 218 to the array 302a, as was discussed in association with FIG. 3. By contrast, if an extent (E2) is promoted from the RAID 0 array 302b to the cache 218, the size of the cache 218 may be kept the same or increased to reflect the decreased amount of time it will take to destage the extent from the cache 218 to the array 302b, as was also discussed in association with FIG. 3.

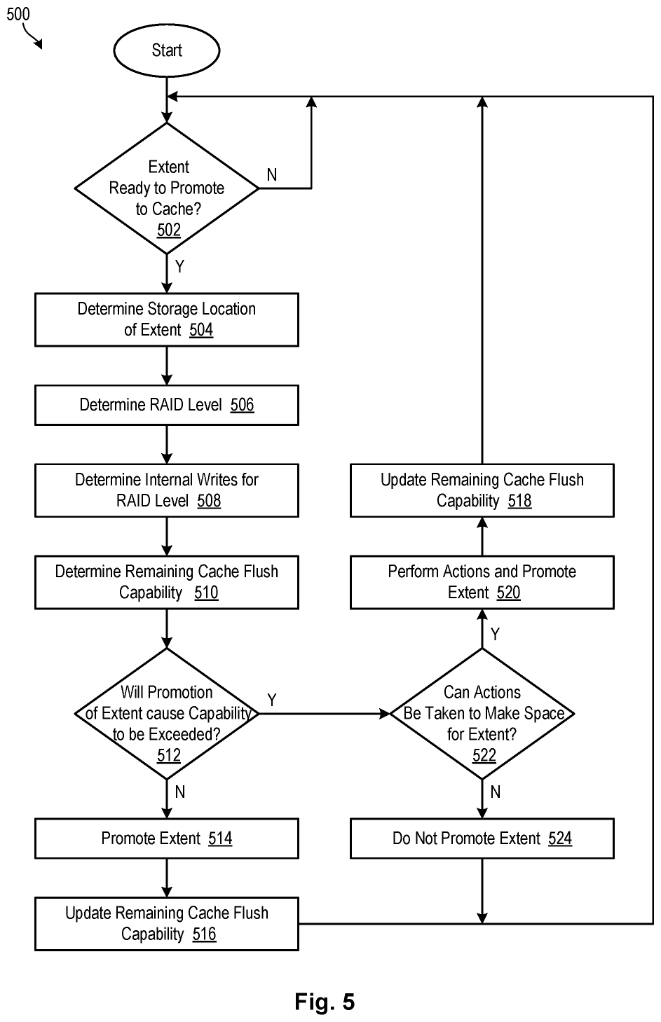

Referring to FIG. 5, a flow diagram showing one embodiment of a method 500 for promoting data from a RAID to cache 218 is illustrated. As shown, the method 500 initially determines 502 whether an extent is ready to be promoted from the storage drives 204 to the cache 218. This may be the result of the extent being accessed or changing in temperature. If so, the method 500 determines 504 the location of the extent on the storage drives 204 and determines 506 a RAID level associated with the RAID on which the extent is stored. The method 500 then determines 508 a number of internal writes that are associated with the RAID level. This may indicate the amount of time that will be needed to destage this extent back to the RAID from which it originates.

The method 500 may then determine 510 a remaining cache flush capability. That is, the method 500 may determine 510 an amount of additional data that may be added to the cache 218 before the ability of the battery 300 to flush the contents of the cache 218 is exceeded. At this point, the method 500 may determine 512 whether promotion of the extent to the cache 218 will cause this capability to be exceeded. As previously mentioned, this may depend on a number of internal writes that are associated with the RAID level of the RAID on which the extent is stored.

If, at step 512, promoting the extent will not cause the remaining cache flush capability to be exceeded, the method 500 may promote 514 the extent from the storage drives 204 to the cache 218. The method 500 may then update 516 the cache flush capability to reflect the promotion of this extent to cache 218. In certain embodiments, the cache flush capability is maintained in the form of a number and updating 516 the cache flush capability is accomplished by adding the number of internal writes associated with the promoted extent to the cache flush capability.

If, at step 512, promoting the extent will cause the remaining cache flush capability to be exceeded, the method 500 may determine 522 whether actions can be taken to make space in the cache 218 to accommodate the extent. These actions may include, for example, destaging another extent from the cache 218 to make space for the extent being promoted. If actions can be taken to clear room in the cache 218, the method 500 may perform 520 the actions and promote 520 the extent from storage drives 204 to the cache 218, assuming the promotion does not cause the remaining cache flush capability to be exceeded. The remaining cache flush capability may then be updated 518 to reflect both the promotion of the extent and the destaging or other actions performed to clear space for the extent. If, on the other hand, no actions are available to clear sufficient space in the cache 218 to promote the extent, the extent may not be promoted at step 524.

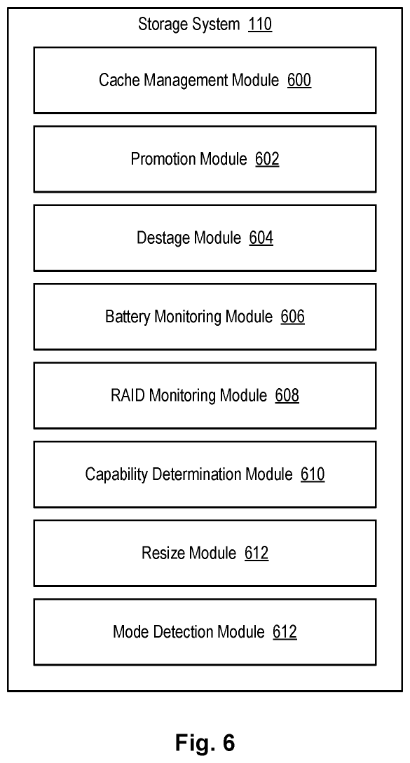

Referring to FIG. 6, a high-level block diagram is provided showing modules that may be used to implement various features and functions of the invention. These modules may be implemented in hardware, software, firmware, or combinations thereof. The modules are presented by way of example and not limitation. More or fewer modules may be provided in different embodiments. For example, the functionality of some modules may be combined into a single or smaller number of modules, or the functionality of a single module may be distributed across several modules. Although the modules are shown within a storage system 110, they are not limited to implementation within a storage system 110. Thus, the location of the modules is provided by way of example and not limitation.

As shown, the modules may include one or more of a cache management module 600, promotion module 602, destage module 604, battery monitoring module 606, RAID monitoring module 608, capability determination module 610, resize module 612, and mode detection module 612.

The cache management module 600 may be configured to manage data, such as modified data, in the cache 218. This may include determining when to promote data from persistent storage drives 204 to the cache 218 as well as destaging data from the cache 218 to the persistent storage drives 204. The promotion module 602 may be configured to promote data from the persistent storage drives 204 to cache 218, and the destage module 604 may be configured to destage data from cache 218 to the persistent storage drives 204.

The battery monitoring module 606 may be configured to monitor a battery configured to provide backup power to the cache 218. The battery monitoring module 606 may monitor overall energy levels of the battery 300. The battery monitoring module 606 may also monitor for power outages or other faults that may cause the cache 218 to go on battery 300.

The RAID monitoring module 608, by contrast, may monitor RAID arrays that provide backend storage behind a cache 218. For example, the RAID monitoring module 608 may determine RAID levels that are associated with particular RAIDs from which data is being promoted or to which data is being destaged. This may facilitate determining how long it takes to destage data to particular RAIDs, such as by indicating how many internal writes are needed to write data to particular RAIDs. Alternatively, or additionally, the RAID monitoring module 608 may determine write latency by simply observing how long destages take to complete to particular RAIDs. This may be a one-time observation or observations occurring over a period of time.

Using the information from the battery monitoring module 606 and RAID monitoring module 608, the resize module 612 may resize the cache 218 accordingly. For example, if the battery monitoring module 606 indicates that battery energy levels are falling, the resize module 612 may reduce the size of the cache 218 to ensure that all data in the cache 218 may be destaged in the event of an emergency such as a power outage. Increases in battery energy levels may cause the opposite to occur. The resize module 612 may also reduce the size of the cache 218 in the event data is promoted to the cache 218 from RAIDs that require more internal writes when destaging data thereto. It follows that the resize module 612 may increase the size of the cache 218 in the event data is promoted to the cache 218 from RAIDs requiring less internal writes when destaging data thereto.

The capability determination module 610 may determine the capability of a cache 218 to store data. In certain embodiments, the capability determination module 610 may maintain a numeric value, referred to herein as a remaining cache flush capability, that indicates how much remaining cache 218 capacity is available to store data. This value may be important to determine whether additional extents may be promoted to cache 218, or if extents need to be destaged from cache 218 in order to make room for other extents.

The mode detection module 612 may determine in what mode the cache 218 is operating. These modes may include, for example, normal mode and emergency mode. In normal mode, the battery monitoring module 606, RAID monitoring module 608, resize module 612, and the like may perform in the manner previously described. However, when the storage system 110 transitions into emergency mode, which may be triggered, for example, by a fault or power outage, resources of the storage system 110 may be dedicated to destaging all data in the cache 218 to more persistent storage drives 204. Thus, the mode detection module 612 may detect in which mode the storage system 110 is operating so resources may be allocated accordingly.

Communication between the battery monitoring module 606, RAID monitoring module 608, and resize module 612 may, in certain embodiments, be facilitated using out-of-band protocols. In other embodiments, reserved fields in a write CDB (e.g., SCSI CDB) may be used to communicate information between layers (i.e., modules) within a storage controller 200. The SCSI Command Descriptor Block (CDB) is a block of information that describes a command. Each CDB may be 6, 10, 12, or 16 bytes. Later versions of the SCSI standard allow for variable-length CDBs. A CDB typically includes a one-byte operation code followed by some command-specific parameters.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for resizing write cache in a storage system, the method comprising:
maintaining, in a write cache, write data to be destaged to a RAID array implemented on persistent storage drives;
determining a RAID level associated with the RAID array;
from the RAID level, determining write amplification associated with the RAID array, the write amplification reflecting a number of backend writes occurring internally within the RAID array when the write data is destaged from the write cache to the RAID array; and
dynamically resizing the write cache in a way that takes into account the following: (1) an amount of battery power available to destage the write data to the persistent storage drives in the event of an emergency; and (2) the write amplification occurring within the RAID array.

2. The method of claim 1, wherein dynamically resizing the write cache comprises calculating a cache flush capability associated with the write cache, the cache flush capability reflecting an amount of data capable of being flushed from the write cache using the battery power.

3. The method of claim 2, further comprising rejecting requests to promote data to the write cache that would cause the write cache to exceed its cache flush capability.

4. The method of claim 2, further comprising accepting requests to promote data to the write cache that would not cause the write cache to exceed its cache flush capability.

5. The method of claim 2, further comprising updating the cache flush capability in response to changes to the amount of battery power.

6. The method of claim 1, wherein the write data comprises an extent of write data.

7. The method of claim 1, wherein the emergency is a power outage.

8. A computer program product for resizing write cache in a storage system, the computer program product comprising a computer-readable storage medium having computer-usable program code embodied therein, the computer-usable program code configured to perform the following when executed by at least one processor:
maintain, in a write cache, write data to be destaged to a RAID array implemented on persistent storage drives;
determine a RAID level associated with the RAID array;
from the RAID level, determine write amplification associated with the RAID array, the write amplification reflecting a number of backend writes occurring internally within the RAID array when the write data is destaged from the write cache to the RAID array; and
dynamically resize the write cache in a way that takes into account the following: (1) an amount of battery power available to destage the write data to the persistent storage drives in the event of an emergency; and (2) the write amplification occurring within the RAID array.

9. The computer program product of claim 8, wherein dynamically resizing the write cache comprises calculating a cache flush capability associated with the write cache, the cache flush capability reflecting an amount of data capable of being flushed from the write cache using the battery power.

10. The computer program product of claim 9, wherein the computer-usable program code is further configured to reject requests to promote data to the write cache that would cause the write cache to exceed its cache flush capability.

11. The computer program product of claim 9, wherein the computer-usable program code is further configured to accept requests to promote data to the write cache that would not cause the write cache to exceed its cache flush capability.

12. The computer program product of claim 9, wherein the computer-usable program code is further configured to update the cache flush capability in response to changes to the amount of battery power.

13. The computer program product of claim 8, wherein the write data comprises an extent of write data.

14. The computer program product of claim 8, wherein the emergency is a power outage.

15. A system for resizing write cache in a storage system, the system comprising:
at least one processor;
at least one memory device operably coupled to the at least one processor and storing instructions for execution on the at least one processor, the instructions causing the at least one processor to:
maintain, in a write cache, write data to be destaged to a RAID array implemented on persistent storage drives;
determine a RAID level associated with the RAID array;
from the RAID level, determine write amplification associated with the RAID array, the write amplification reflecting a number of backend writes occurring internally within the RAID array when the write data is destaged from the write cache to the RAID array; and
dynamically resize the write cache in a way that takes into account the following: (1) an amount of battery power available to destage the write data to the persistent storage drives in the event of an emergency; and (2) the write amplification occurring within the RAID array.

16. The system of claim 15, wherein dynamically resizing the write cache comprises calculating a cache flush capability associated with the write cache, the cache flush capability reflecting an amount of data capable of being flushed from the write cache using the battery power.

17. The system of claim 16, wherein the instructions further cause the at least one processor to reject requests to promote data to the write cache that would cause the write cache to exceed its cache flush capability.

18. The system of claim 16, wherein the instructions further cause the at least one processor to accept requests to promote data to the write cache that would not cause the write cache to exceed its cache flush capability.

19. The system of claim 16, wherein the instructions further cause the at least one processor to update the cache flush capability in response to changes to the amount of battery power.

20. The system of claim 15, wherein the write data comprises an extent of write data.
